(19) United States
(12) Patent Application Publication
(10) Pub. No.: US 2010/0235287 A1
(43) Pub. Date: Sep. 16, 2010

(54) METHOD FOR OUTSOURCING TECHNOLOGY SERVICES

(76) Inventors: Gregg John Lymbery, Wellington (NZ); Stephen M. Pratt, Wellington (NZ); Peter John Cook, Wellington (NZ)

Correspondence Address: UNISYS CORPORATION, UNISYS WAY, MAIL STATION: S1-108, BLUE BELL, PA, 19424, US

(21) Appl. No.: 12/303,983

(22) PCT Filed: Jun. 30, 2006
(86) PCT No.: PCT/US06/25685

§ 371 Date: Dec. 9, 2008

(51) Int. Cl. G06Q 10/00; G06Q 50/00

(52) U.S. Cl. 705/80

(57) ABSTRACT

A method of outsourcing technology. Metrics are determined to govern services by agreement between a client and an outsourcer. Services required by the client are selected from a fixed list of services and a quality for the selected service is determined, the selection and the quality being dependent on the metrics. The services within the fixed list of services are organised within groups and at least one service corresponds to a predetermined practice. An agreement is generated for the provision of each selected service, and the provision of each selected service is allocated to an appropriate technology service provider. Each technology service provider provides its allocated service according to the quality required and according to the corresponding practice. The services provided in conjunction are monitored and the quality of the services is adjusted or additional services are added from the list in response to the outcome of the monitoring.

### CROSS REFERENCE TO RELATED APPLICATIONS

The present application claims the benefit of the following PCT Applications: PCT Application Number: PCT/US2006-025685 entitled, “A Method for Outsourcing Technology Services”, PCT/US2006-025678, entitled “A System for Assisting the Generation of an Agreement for Outsourcing Technology Service”; PCT/US2006-025677, entitled “A System for Outsourcing Technology Services” and PCT/US2006-025686, entitled “A Method for Facilitating the Outsourcing of Technology Services”. The subject matter of each of which is incorporated by reference herein.

### FIELD OF INVENTION

The present invention relates to a method of outsourcing technology services.

### BACKGROUND TO THE INVENTION

In order to reduce costs, organisations (clients) often outsource to another party (the outsourcer) the technology required in the organisation. In such instances, the client generally enters into an agreement with the outsourcer in order to ensure that the technology and services to be provided are adequately provided and that there is a legally binding agreement for the provision of the outsourced services. It will be appreciated that the provision of some technology services, such as information technology services, involves a very great number of interrelated services. Consequently, reaching an agreement about the services to be provided by an outsourcer for a client can be an exceedingly complex process.

Conventional methods for entering into an outsourcing agreement include a standardised agreement, provided by the outsourcer, which is then modified to suit the requirements of the client. Alternatively, a new agreement may be created. In addition, the resultant agreement must be monitored in order to ensure that the agreed services are provided in accordance with the agreement and to ensure that the agreed services adequately meet the needs of the client.

There are several difficulties encountered when outsourcing technology. For example, it is difficult to maintain standardisation within the agreement between the client and the outsourcer while providing the ability for a client-centric approach to providing services (i.e. a customised approach). In addition, it is difficult to ascertain precise terms of the agreement, often because the agreement has not been captured adequately. Much of this is further complicated by the fact that traditional agreements are difficult to negotiate and modify as they are structured in view of the way they are negotiated and the number of people and functional groups involved. It is also difficult to add customised information to such agreements, since they may be lengthy and additions of information must be made manually. This may result in additions being made at inappropriate places in the contract and requires significant user effort and time.

Existing methods provide neither a structured approach to outsourcing negotiations nor do they provide for a structured approach to modifying an agreement based on monitoring of the delivery of the services agreed on. The result of existing methods of outsourcing is often an inconsistent definition of the outsourcing agreement and service demarcation because these methods are based on delivery experience rather than contract generation. In addition, there are few adequate methods of monitoring the resultant outsourcing agreement to ensure that the services are provided in accordance with the agreement and to monitor to ensure that the services contracted are adequate.

Therefore, it is an object of the present invention to overcome the above disadvantages of existing methods of technology outsourcing by providing a more effective method and system for outsourcing technology, or to at least provide the public with a useful choice.

### SUMMARY OF THE INVENTION

According to a first aspect of the invention there is provided a computer-implemented method of outsourcing technology services, comprising the steps of: determining metrics to govern services by agreement between a client and an outsourcer; selecting services required by the client from a fixed list of services and determining a quality for the selected service, wherein the selection and the quality of the selected services are dependent on the metrics, and wherein the services within the fixed list of services are organised within groups and at least one service corresponds to a predetermined practice; generating an agreement between the outsourcer and the client for the provision of each selected service; allocating the provision of each selected service to an appropriate technology service provider; each technology service provider providing its allocated service according to the quality required and according to the corresponding predetermined practice; monitoring the services provided in conjunction with the client; and adjusting the quality of the services or adding additional services from the list in response to the outcome of the monitoring.

Preferably the services are information technology services. The metrics may relate to any one or more from the set of the frequency of delivery; the quality of the service; the availability of components of the environment; and the ability of the environment to support the business.

The method preferably also includes the step of determining a responsible party for delivery of the service from one of the outsourcer, the client, or a third party. The method preferably also includes the step of defining a plurality of environments for the client.

The method may include the step of determining a responsible party for delivery of the service for each of the environments of the client, the responsible party being selected from one of the outsourcer, the client, or a third party.

The environments are preferably defined by one of infrastructure, data or business environments and the groups of services are preferably organised based on functional grounds. The services may include administration services, support services, maintenance services, and infrastructure services and the fixed list of services may include administration services, support services, maintenance services, and infrastructure services.

Preferably the services are grouped into groups of one or more services from the set of account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, internet services, application support capacity planning, architecture, consulting services & supplementary services, data management, network management, and system management. Preferably the services are ordered by grouping from administration services, support services, maintenance services, to infrastructure services.

In a second aspect the invention provides a computer-implemented method of determining pricing for one or more technology outsourcing services, comprising the steps of: one or more operational delivery groups delivering technology outsourcing services using a list of services for one or more clients, wherein each service includes a level of quality for the service and each service corresponds to a process for performing the service and wherein each process defines working practices; generating costs for each service delivered; compositing the costs into a cost model for all services delivered; and, generating a pricing model from the cost model.

In a third aspect the invention provides a computer-readable medium having stored thereon a computer program comprising instructions which, when executed by a computer, cause the computer to perform the steps of determining metrics to govern services by agreement between a client and an outsourcer; selecting services required by the client from a fixed list of services and determining a quality for the selected service, wherein the selection and the quality of the selected services are dependent on the metrics, and wherein the services within the fixed list of services are organised within groups and at least one service corresponds to a predetermined practice; generating an agreement between the outsourcer and the client for the provision of each selected service; allocating the provision of each selected service to an appropriate technology service provider; each technology service provider providing its allocated service according to the quality required and according to the corresponding predetermined practice; monitoring the services provided in conjunction with the client; and, adjusting the quality of the services or adding additional services from the list in response to the outcome of the monitoring.

### BRIEF DESCRIPTION OF THE DRAWINGS

The present invention and its features, nature, and advantages are best understood from the following detailed description which, when read in connection with the accompanying description, illustrate specific embodiments of the present invention:

FIG. 1: shows an example of a framework within which the method of the invention may be used;

FIG. 2: shows an example of a list of services from which required services may be selected;

FIG. 3: shows an example of a table allowing selection of suppliers for selected services in each environment, and receipt of further information from a user via a free-form text-input;

FIG. 4: shows a flowchart illustrating a preferred embodiment of the method of the invention;

FIG. 5: shows a block diagram illustrating the structure of environments defined within a preferred embodiment of the method of the invention;

FIG. 6: shows a hierarchical list of services related to the main service “Service Desk;”

FIG. 7: shows a portion of a contract schedule generated by a method of the invention;

FIG. 8: shows a diagram illustrating how a service provision is monitored and adjusted according to a preferred embodiment of the method of the invention; and,

FIG. 9: shows a diagram illustrating how a pricing model can be generated in accordance with a method of the invention.

FIG. 10: shows one embodiment of a computer system on which the invention may be implemented.

### DETAILED DESCRIPTION OF PREFERRED EMBODIMENTS

The present invention will be described in relation to information technology services outsourcing. However, it will be appreciated that, with modifications, the method may be adapted for use with outsourcing of other technology services.

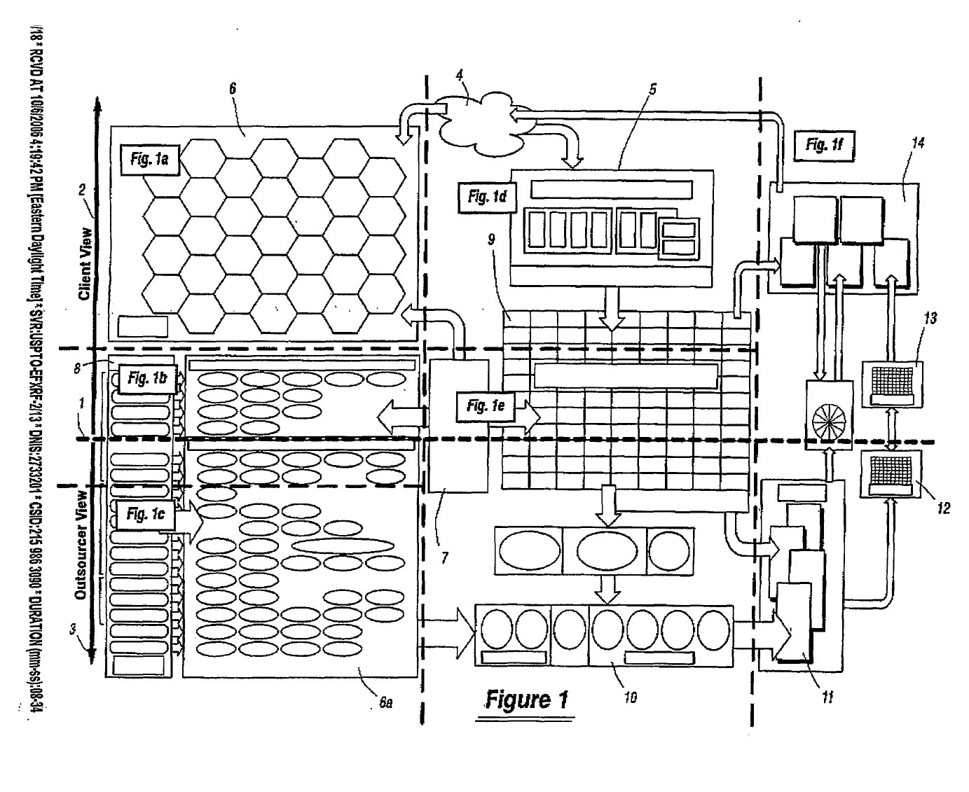

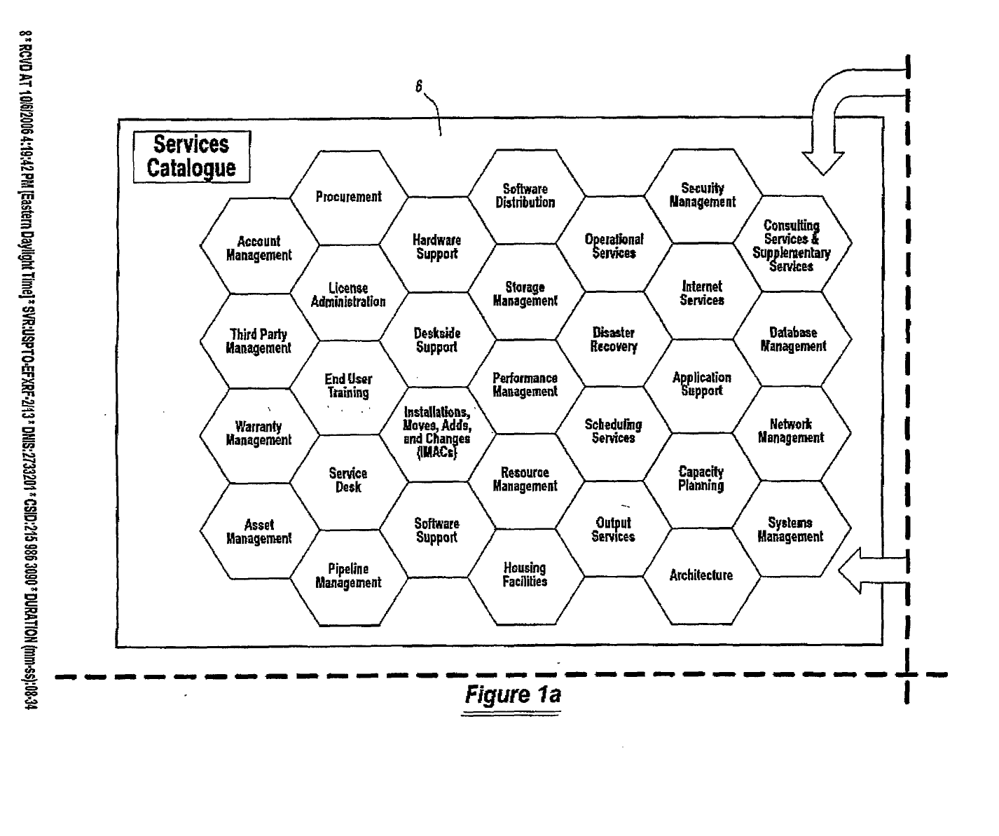

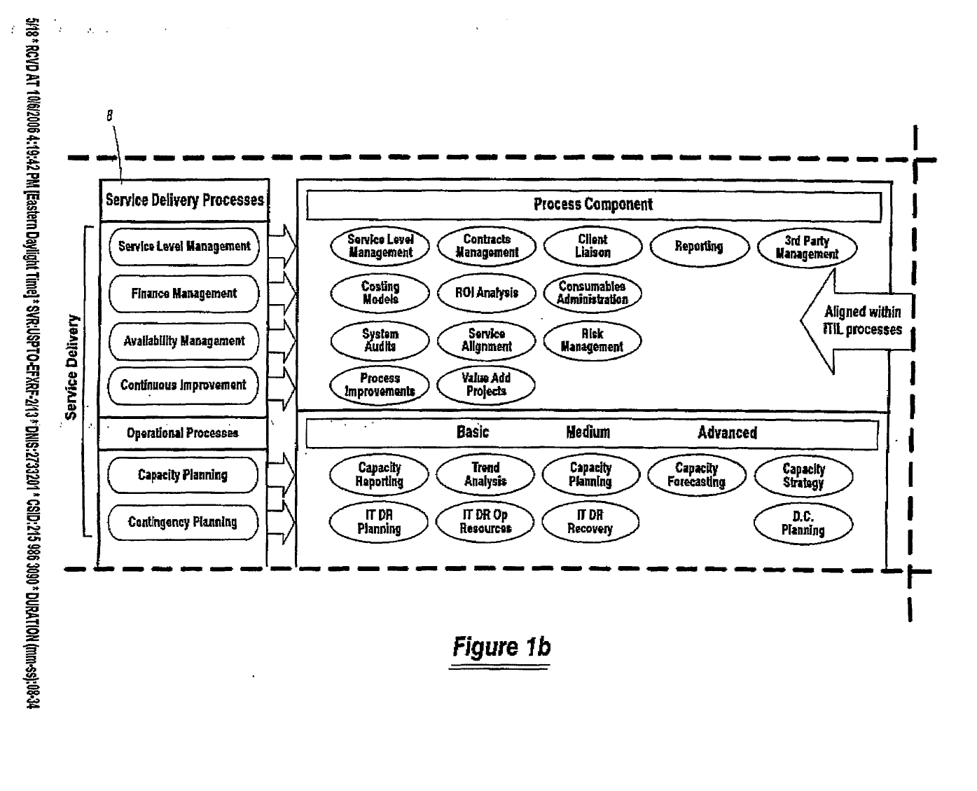

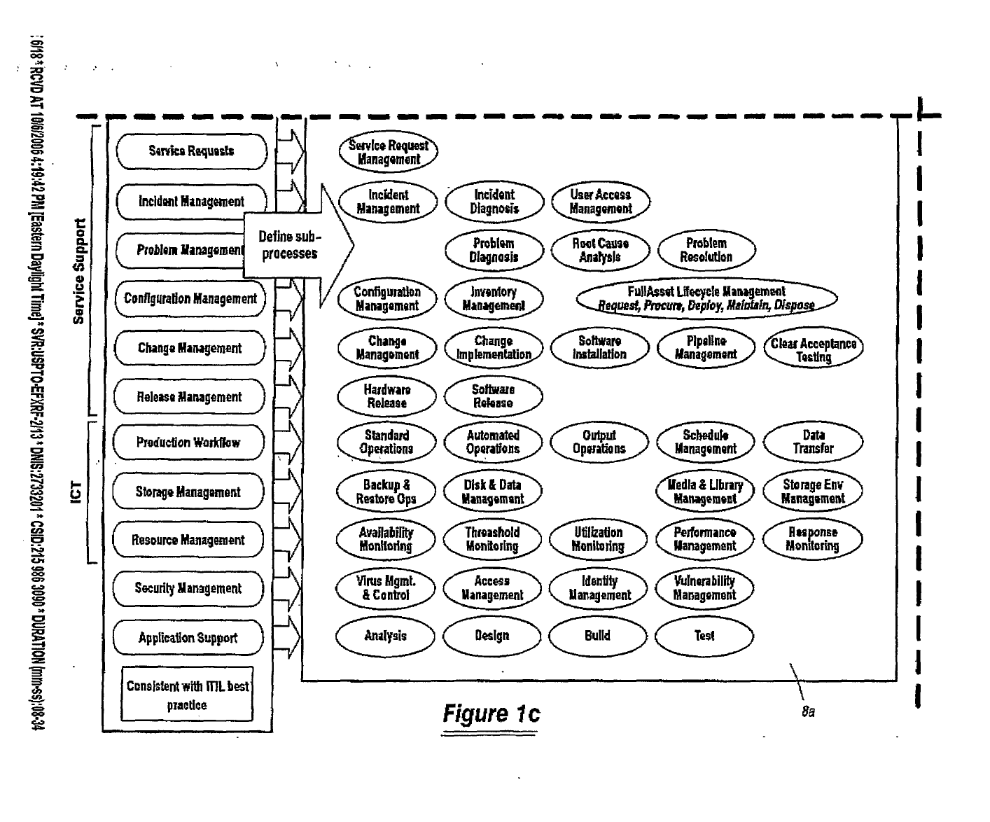

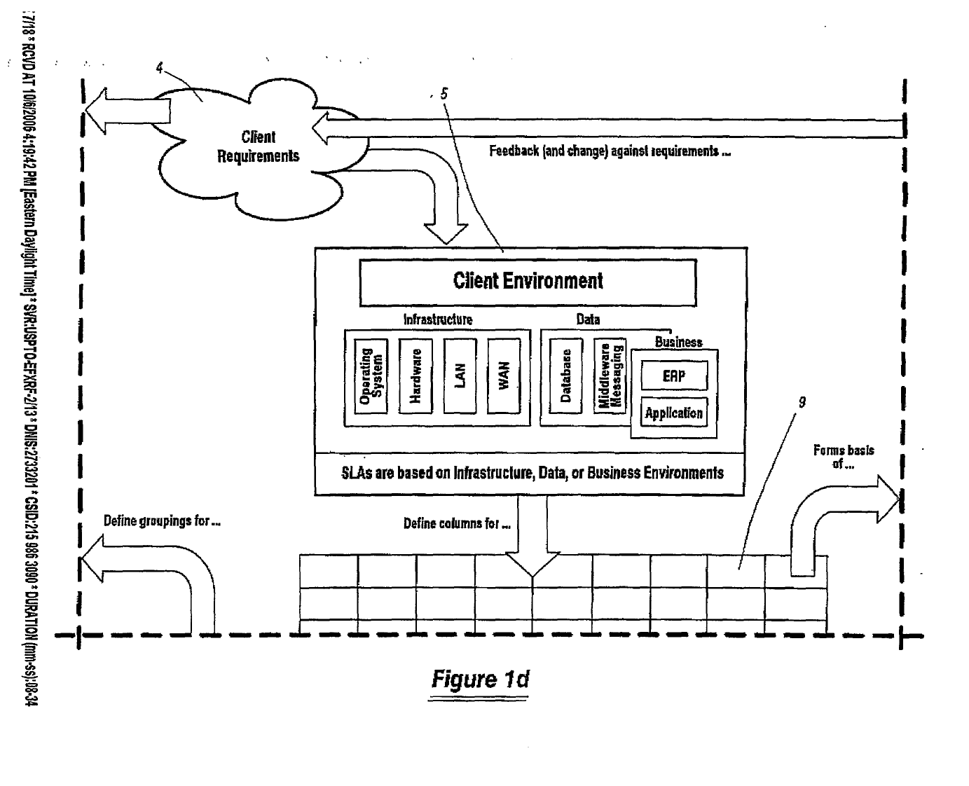

In one embodiment, the method of the invention may be used within a wider framework that facilitates a consistent approach to selling, delivering and monitoring information technology outsourcing services. FIG. 1 shows an example of such a framework. FIGS. 1a, 1b and 1c are as a whole identical to FIG. 1, but show the framework in greater detail.

With reference to FIG. 1 the components of the framework may be horizontally split along dashed line 1 into two conceptual views. In use, the client focuses on the components shown in the upper level 2. The components in the upper level relate to services required by the client and outcomes the client wants to achieve. In use, the outsourcer focuses on the components shown in the lower level 3. The components in the lower level 3 relate to how the services will be delivered. FIG. 1 illustrates how client requirements May be translated into specific tasks to be performed by the outsourcer. This model provides clients with some visibility of the delivery model for the outsourced services but does not require exploration by the client of the specific tasks or resources required in delivering the services. Some components may require input from both the client and the outsourcer, or agreement between the client and the outsourcer, as described below.

According to the framework shown in FIG. 1, client background information and the client's requirements 4 may be gathered from the client. These requirements may be extracted during a consultative process. A full understanding by the outsourcer of the requirements and the client's technology structures assists in understanding the services the client is expecting and the services for which the outsourcer will be responsible.

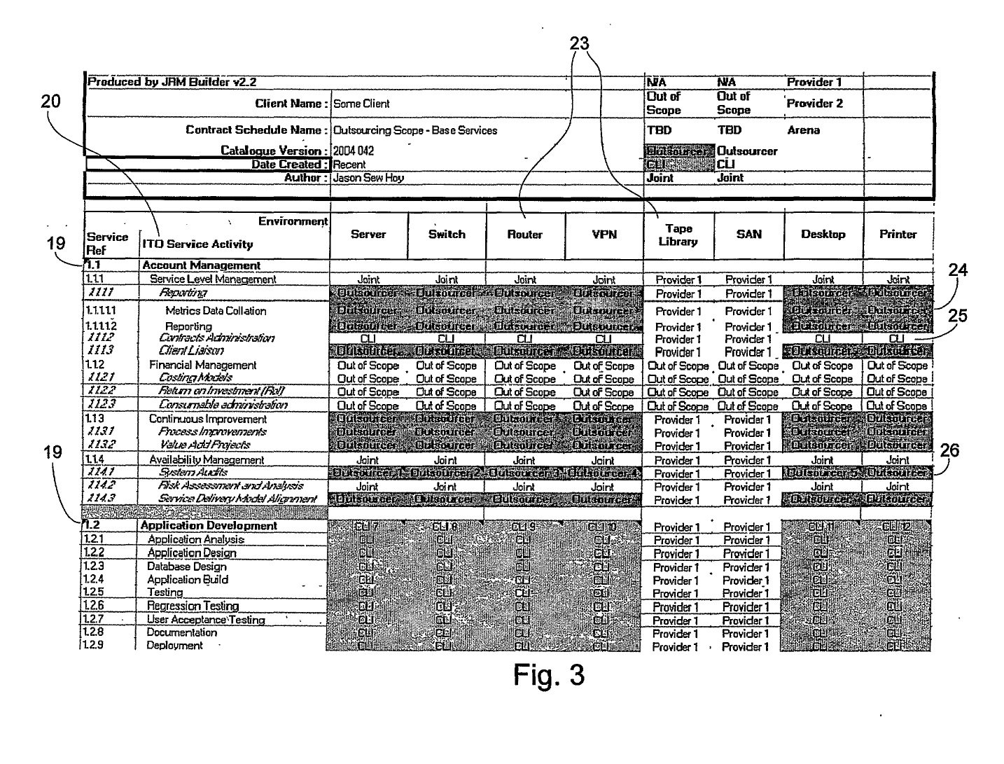

The framework preferably allows definition of the customer environments 5. The customer environments 5 provide the context in which the services are provided. This definition may take a variety of forms depending on the client requirements. For example the environment may be described at a technology level including elements such as servers, printers, routers etc. Such environments might include a server environment and a tape library environment, for example, as shown generally at 23 in FIG. 3. Alternatively the environment may be described at a business systems level including elements such as payroll system, messaging system, application system etc. Such environments might include a payroll environment and an accounts-payable environment, for example. Other environments as known to those of skill may be included, and they are intended to be within the purview of the present invention. From the perspective of the outsourcer, each client environment may require a different combination of services, metrics and service levels appropriate to the technology and appropriate to the way that the services are delivered.

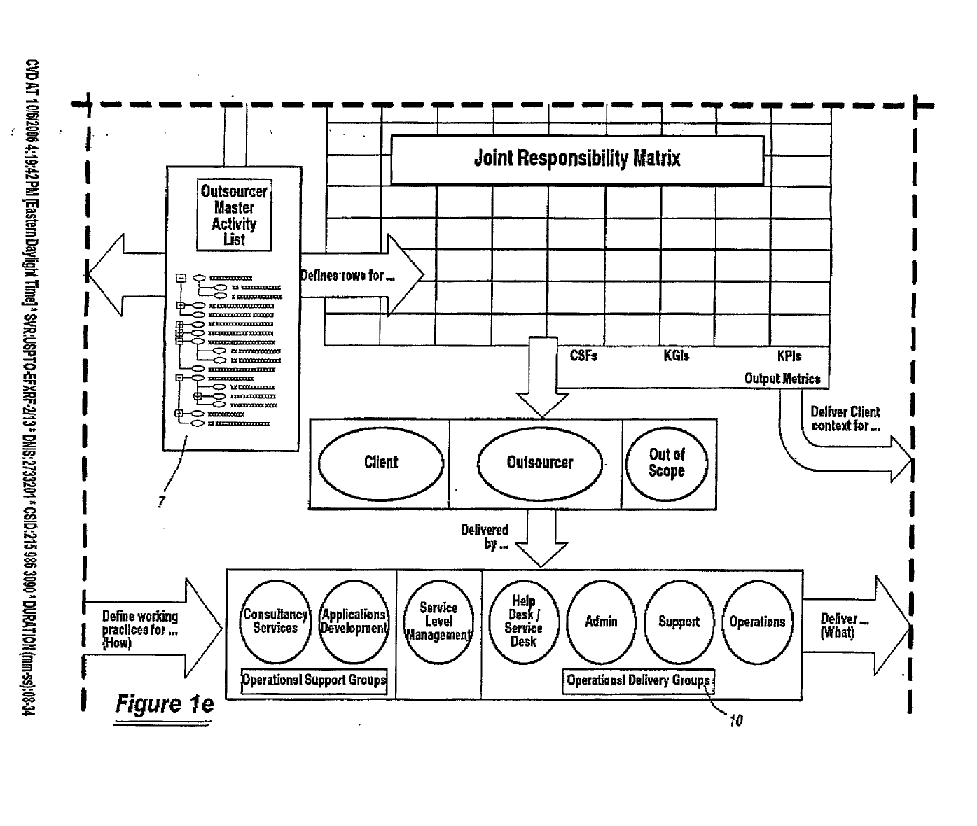

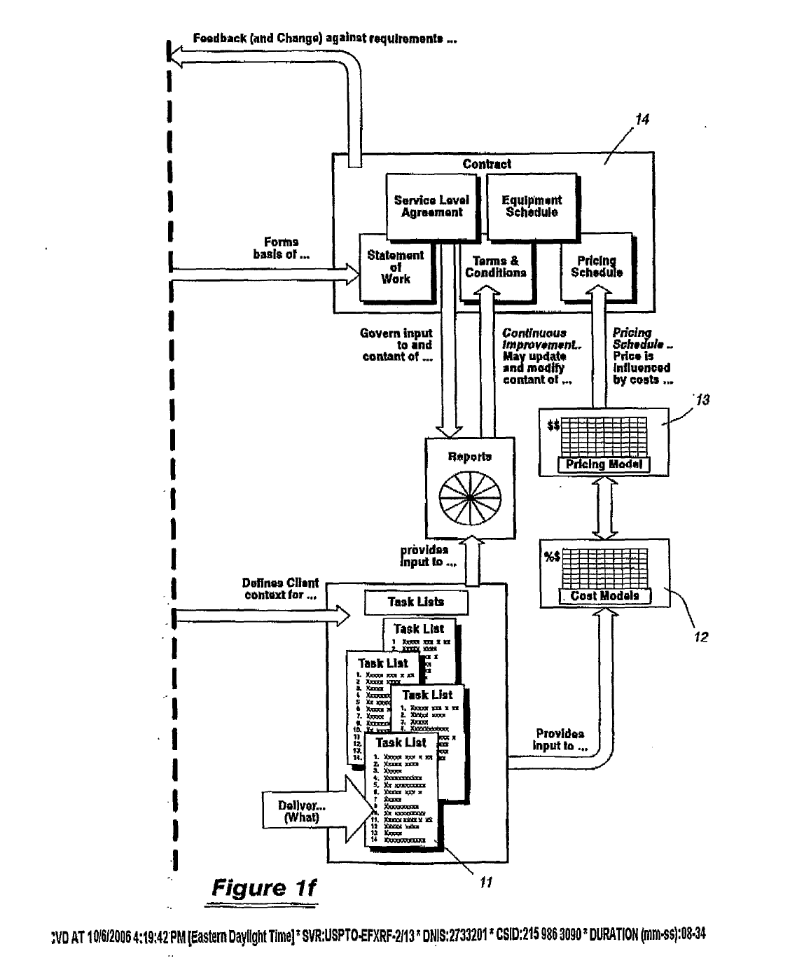

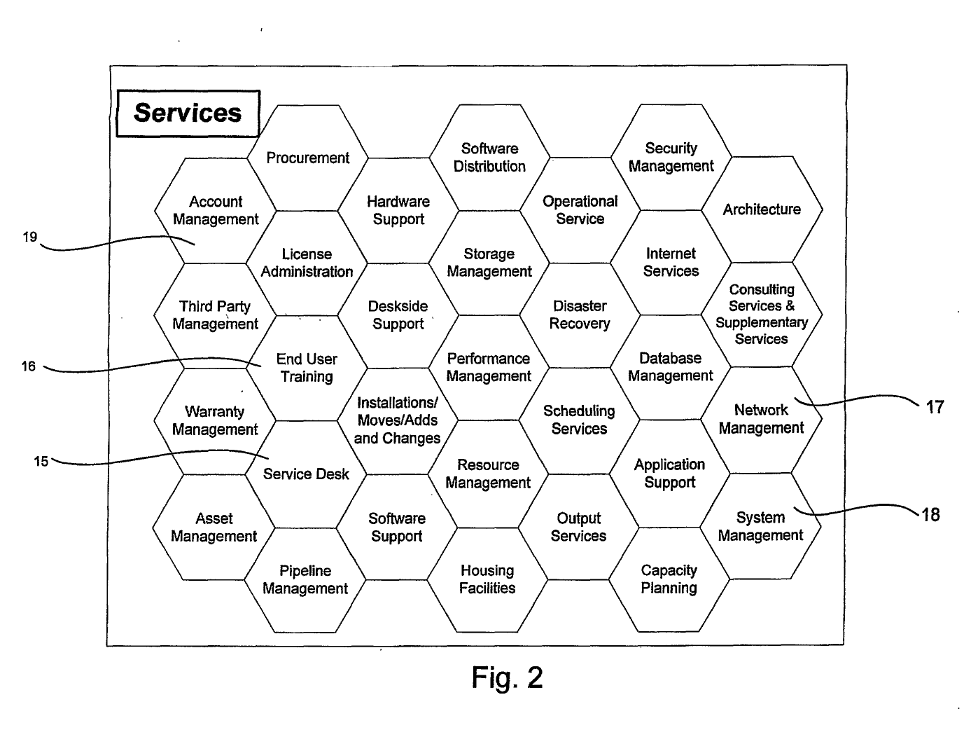

The client requirements 4 may also be used to determine the key services e.g. 15, 16, 17, 18, 19 (FIG. 2) to be provided in each identified environment 5. The key services e.g. 15, 16, 17, 18, 19 may be chosen from a fixed list of available services (for example, the list shown in FIG. 2), where the fixed list is a list which has resulted from a thorough consideration of the issues involved in outsourcing technology and from the extensive experience of outsourcers. The list shows what the outsourcer can deliver to the client and is preferably ordered or arranged in groups based on a functional relationship. For example, “Service Desk” is listed next to “End User Training” because service desk is related to end user training. The list or matrix may also include elements representing collections of services packaged into a well defined portfolio solution, for example, network management, and systems management. The key services shown in FIG. 2 have been developed utilising extensive experience to provide an optimal arrangement of services for an outsourcer to provide to a client. However, it will be appreciated that, although this list of key services is preferred, a modified list of services could be employed.

In the preferred embodiment the fixed list of available key services is shown as a honeycomb matrix 6, such as that shown in FIG. 2. The honeycomb matrix provides a clear high level menu of key services typically required in an information technology environment. It is also preferred that the list or matrix of key services is displayed on a graphical user interface.

The presentation of an ordered or grouped list or matrix of key services from which the client can select required services has several advantages including, but not limited to: facilitating communication of the available key services to the clients; providing high level key service descriptions to assist in scoping the outsourcing agreement; allowing the value of specific key services to be highlighted and recognised; and, allowing indicative pricing to be quickly calculated. The use of this list also ensures that all relevant services are brought to the attention of the client and/or the outsourcer. It is therefore less likely that the parties will forget a particular service—their attention will necessarily be drawn to each relevant service.

Each of the key services e.g. 15, 16, 17, 18, 19 can be decomposed into a list of sub-services. In this specification, the term “services” is intended to include key services and sub-services unless the context clearly requires otherwise. The Master Activity List 7, is preferably a complete list of key services and the sub-services that make up the key services e.g. 15, 16, 17, 18, 19 in the identified environment 5. The Master Activity List 7 contains an appropriate level of detail to be used within the Statement of Work contained in the outsourcing agreement, and each sub-service in the Master Activity List 7 is specific to a single key service e.g. 15, 16, 17, 18, 19. The Master Activity List 7 also provides clarification about what aspects of the key service e.g. 15, 16, 17, 18, 19 the client requires. Each sub-service may be further decomposed into another list of services. A hierarchy of several levels of services may thus be created.

The services in the Master Activity List 7 are associated with a set of delivery processes 8. The delivery processes 8 are preferably consistent with Information Technology Infrastructure Library best practices. The ITIL is a well-known framework of supplier-independent best practice approaches for delivery of information technology (IT) services. Consistency with the ITIL therefore ensures that the services performed by the outsourcer comply with recognised information technology best practices.

The services in the Master Activity List 7 may define the rows in a Joint Responsibility Matrix 9. The Joint Responsibility Matrix 9 allows a user to define the party responsible for providing each service in the Master Activity List 7 in each environment of the client. Thus the Joint Responsibility Matrix 9 provides an easily understandable visual display, so that it is easy to see who is responsible for service-delivery, which services have yet to be assigned to a provider etc. With reference to FIG. 3 an exemplary Joint Responsibility Matrix 9 is displayed on a graphical user interface. The rows 20 of the Joint Responsibility Matrix 9 are defined by the services in the Master Activity List 7 including the key services e.g. 15, 16, 17, 18, 19 and the sub-services that make up the key services. Each key service 19 is shown as a heading using font variation, justification, and numerals. Underneath each key service 19 are sub-services related to the key service.

The columns in the Joint Responsibility Matrix 9 may be defined by the customer environments 5. As described above, the environments can be defined as any logical grouping. For example, there may be environments of the client based on geography—“Los Angeles”, “Chicago” and “New York”, or based on business function—“Retail” and “Distribution”, or based on technology—“Servers” and “PCs,” such as shown in FIG. 3. It will be appreciated that a combination of logical groupings may be utilised as well, for example, “Retail Servers”, “Retail PCs”, “Distribution Servers”, and “Distribution PCs”.

Thus, each intersection in the Joint Responsibility Matrix 9 is associated with a particular service in a particular environment, and each is primarily populated with the party responsible for the delivery of the respective activity 7 in the respective environment 5. The responsible parties can include the outsourcer, the client, and one or more other third party service providers. If the parties are unable to agree on a supplier for a particular service in a particular environment, but wish to return to this at a later stage of the negotiations, an indicator may be assigned to that intersection, to remind the parties that they have discussed this point and should return to it.

With further reference to FIG. 1, the outsourcer may also have a set of operational delivery groups 10 responsible for delivering specific services. Each service in the Joint Responsibility Matrix 9 may be assigned to the most appropriate delivery group 10. For example, end user training services may be assigned to an operational delivery group devoted to providing end user training services. In this way it can be ensured that what has been requested with regard to services 15, 16, 17, 18, 19 is able to be delivered.

Task lists 11 can set out the detail of the specific tasks required to deliver the services 7 in each environment 5. The tasks are preferably defined to relate to the specific technology used by the client. The tasks are resource driven and may vary by geography and management capability.

The task lists 11 provide input into cost models 12 and pricing models 13. Cost models 12 contain assessments of the cost of delivery of the services based on what the outsourcer knows about the environments. Pricing models 13 contain assessments of the price to be charged for service delivery, based on the output of the cost models 12, scope and volume of services to be provided and the markup (i.e. profit margin) imposed by the outsourcer. The models 12, 13 are based on extensive industry experience and form part of the outsourcing contract.

The outsourcing contract 14 is designed to turn the client requirements into contractual documents. The contract 14 preferably contains a Statement of Work which may be a text version of the Joint Responsibility Matrix 9 and records the scope of the key services 15, 16, 17, 18 to be provided and clearly defines responsibility for the delivery of each service 7 associated with each key service 15, 16, 17, 18. The Statement of Work may be further modified to clearly document the specific client circumstances and requirements. The contract also preferably includes an equipment schedule that identifies the entire information technology infrastructure that the outsourcer is responsible for at the time of commencement of the contract. Any subsequent variation to this schedule would imply a variation in the service fees payable. The contract also includes a service level agreement which sets out the client's expectations for service delivery using metrics and service levels. These may be aimed at overall business outcomes but may also include specific measurements for a particular service. The outsourcing contract thus produced defines the relationship between the client and the outsourcer. Other contracts or agreements may also be produced between third parties and the client and/or outsourcer.

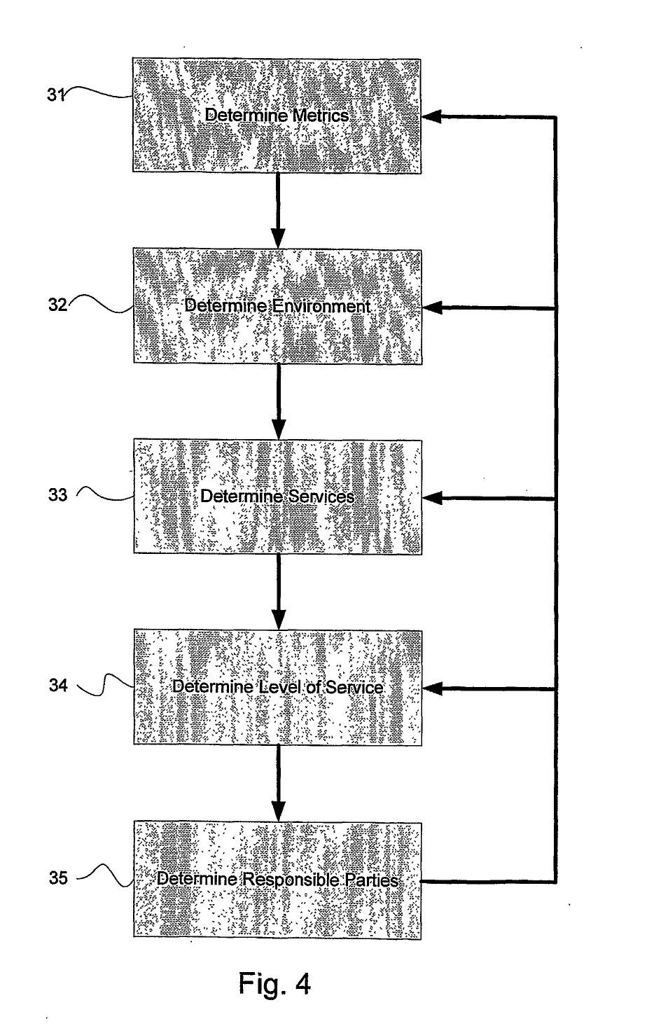

With reference to FIG. 4 a preferred method of the invention will be described. As described above, the client's requirements are gathered from the client. During that process, five stages may be undertaken: Stage 1—determine metrics to govern the services; stage 2—determine the environments of the client; stage 3—determine the services to be provided; stage 4—determine at what level (or quality) the services are to be provided; and stage 5—determine the responsible party for providing the service. It will be appreciated that the stages are not necessarily consecutive. For example, after determining services to be provided, the outsourcer and client may revisit the determination of the environment to add a new environment or to merge two existing environments. Therefore, any permutation of these stages is included within the scope of the present invention.

Stage 1 (step 31) is essentially a discussion process, in which an experienced outsourcing consultant assists the client. This stage is used to determine metrics to govern the services provided by the outsourcer to the client. These metrics will be used to determine which services are to be provided and at what level the services are to be provided, and can relate to any of frequency of delivery; the quality of the service; the availability of components of the environment; and the ability of the environment to support the business. For example, the client and the consultant might determine that a service desk for the client is required to handle 500 phone calls a day. Thus the metric for Service Desk may be 500 calls per day.

Some key metrics that can be used are Critical Success Factor (CSF), Key Goal Indicator (KGI), and/or Key Performance Indicator (KPI). A CSF is an aspect or condition that is required for optimal success or an activity recommend for optimal success. A KGI, representing a process goal, is a measure of what has to be accomplished. It is a measurable indicator of the process achieving its goals, often defined as a target to be achieved. A KPI is a measure of how well the process is performing.

Stage 2 (step 32) is used to determine the environments of the client. While the environments of the client can be based on technology, business, or geographic grounds, it will be appreciated that any structured grouping may be used to determine the environments of the client. For example, the environments of the client may be determined to be a sales environment, covering the retail requirements of the business, and a warehouse environment, covering the storage/distribution of goods requirements of the business.

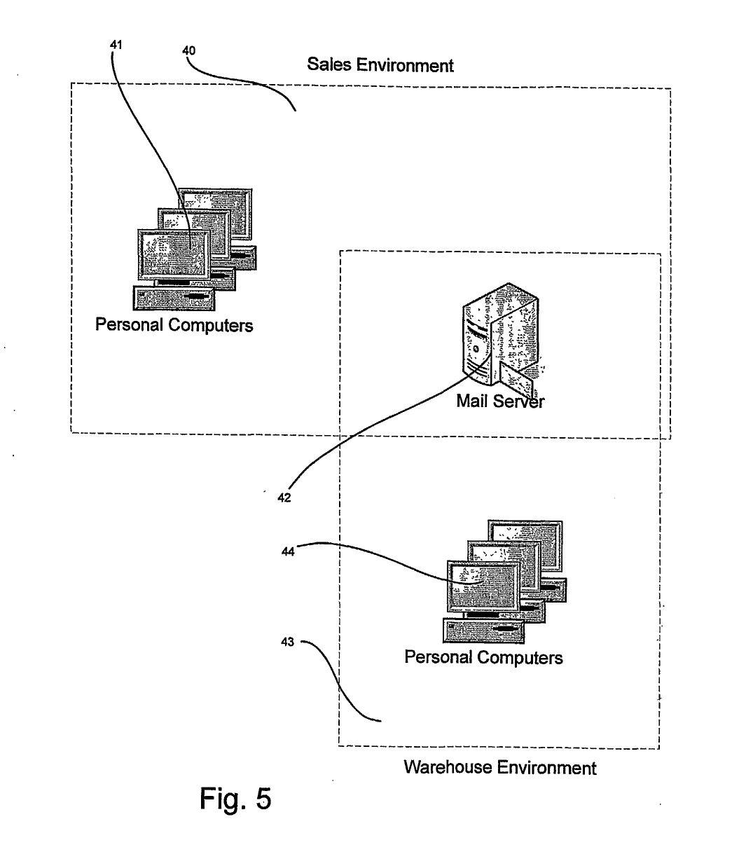

Within each environment the hardware/software systems of the client relevant to that environment are specified. Referring to FIG. 5, an example of an environment structure will be described. Within the sales environment 40 there may be defined a number of Personal Computers 41 and a mail server 42. Where environments use the same hardware, this hardware can be defined to appear in both environments. For example, in addition to the sales environment 40, the warehouse environment 43 may also include a number of Personal Computers 44 capable of communicating with the same mail server 42.

In one embodiment of the invention, users within the environment can also be defined. For example, in a scenario where there are court employees and Judges, the Judges environment can be defined as including fifteen PCs and fifteen Judges. The Court Employees environment can be similarly defined.

In stage 3 (step 33) the technology outsourcer and the client agree on what information technology services the client requires. At this stage the outsourcer and the client may amend the metrics determined earlier and may add additional metrics governing the selected services. This is useful because the desired metrics may change during the discussion process, particularly once it is clear which services are to be provided.

The outsourcer utilises a fixed list of services, for example the Master Activity List 7 to ascertain which services should be provided to the client. A preferred embodiment of such a Master Activity List 7 is described above. The Master Activity List 7 is arranged hierarchically such that each key service in the list heads a group of further services, several of these further services also head a group of yet further services.

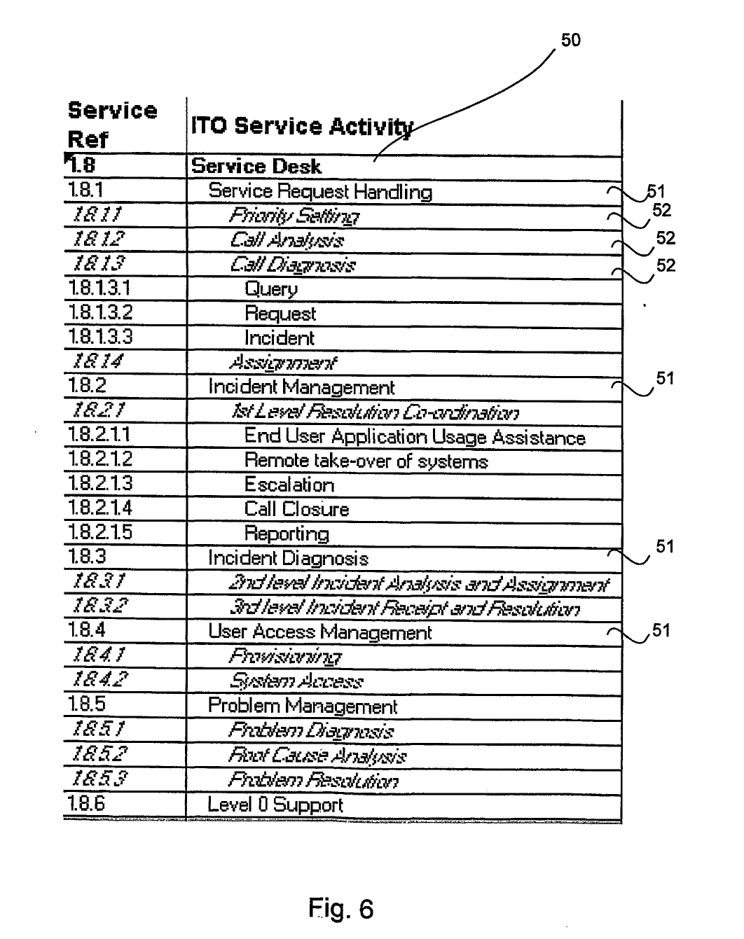

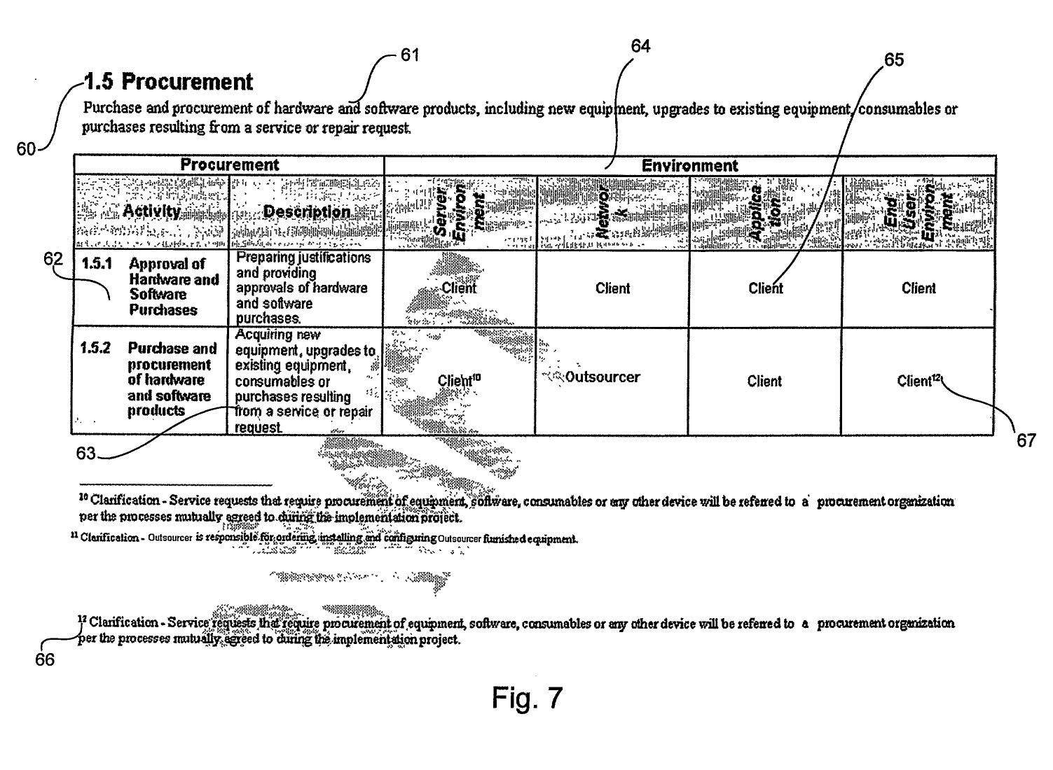

The services are grouped by functional relationship to assist the outsourcer to discuss services related to the service presently under discussion. For example, as shown in FIG. 6, the key service 50, Service Desk, heads numerous other services 51 including Service Request Handling, Incident Management, Incident Diagnosis, and User Access Management. More specifically, the services 51, 52 within a key service 50 are further grouped so that several of these services alio head numerous other services. For example, “Service Request Handling” heads other services 52 including “Priority Setting”, “Call Analysis”, and “Call Diagnosis”. This grouping assists the outsourcer to cover all the services relevant to the client. For example, if “Service Desk” is a requirement of the client then “Service Request Handling” is also very likely relevant.

In addition, the order of the key services 50 within the list is based on functional grounds. Therefore, within the list of key services 50 the key services are ordered from administration services to support services to maintenance services to infrastructure services. For example, “Service Desk” is close to “End User Training” within the list, since a client who needs a service desk will also likely require end user training. This allows the client and the outsourcer to work through the services in a logical manner and to identify further services which may be relevant.

In a preferred embodiment, the order of all the key services is preferably as follows: account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, internet services, application support capacity planning, architecture, consulting services & supplementary services, data management, network management, and system management.

Each service may include a description, which covers more explicitly what the service is providing. The description thus assists the outsourcer and the client to agree specifically on what the service covers. For example, the description for “Service Desk” could be deemed the “provision of a point of contact to log service requests”. This includes event management of all service requests, including: logging, diagnosing and managing incoming calls; prioritising calls against agreed Service Levels; determining the action required to resolve calls; and managing calls through to resolution. The Service Desk also conducts user satisfaction surveys to benchmark and improve user satisfaction in regard to their Service Desk experience.” Of course, alternative descriptions may be used and it will be appreciated that the present invention is meant to encompass all such definitions.

After selecting the service, at stage 4 (step 34), an agreement is also made as to the level of service (quality of service) that is to be provided. The quality is preferably dependent on the metrics to which the parties previously agreed. For example, if the metric for the “Service Desk” is 500 calls per day then the quality (or level) for this service is to provide 500 calls per day. The quality description for each service assists the outsourcer and the client in determining what qualities of the service should be determined. Other standards such as COBIT (Control Objectives for Information and Related Technology) can also be used.

It is advantageous that the services correspond to a predetermined “best practice” as this practice has been established by the outsourcer and is a practice that is most effective in accordance with outsourcer's experience. Each practice defines working practices instructing how to actually deliver the service. However, some of the services 50, 51, 52 may have their practices modified by agreement between the client and outsourcer. For example, a standard practice may be to provide Unisys servers, but the client may request IBM or HP servers.

Further modifications to the quality of service can be agreed to by the outsourcer and the client, and may include inclusions, exclusions, dependencies, or constraints. In addition, the quality of the service can be specified as different for each environment. For example, the retail environment may require “Service Desk” calls to also be handled on Weekends as well as weekdays.

In stage 5 (step 35), the responsible parties for providing the services are specified. The outsourcer is specified as the responsible party for services that the outsourcer and the client agree the outsourcer will provide. The client will be specified as the responsible party for the services that client agrees to provide for themselves. In one embodiment, the outsourcer has arrangements with third parties to provide some of the services, and the outsourcer will specify those third parties as being responsible for those services which the outsourcer and client agree on.

Once the outsourcer and client have agreed on the environments of the client, the services to be provided in the environment, the quality of the service, and the responsible parties, a contract schedule can be generated for a contract between the outsourcer and the client.

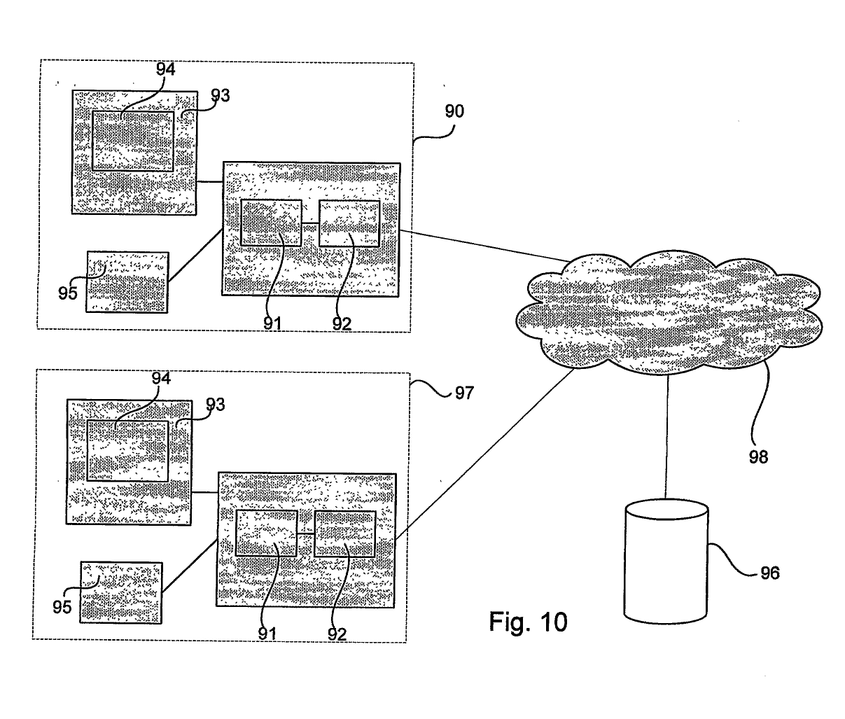

An example of a portion of a contract schedule is shown in FIG. 10. The contract schedule extract includes a statement of the key service to which it relates 60 and a description 61 of that service 15, 16, 17, 18. The schedule also shows a sub-list of services 62 including their descriptions 63. The environments 64 in which the services are to be provided are also shown. The party responsible 65 for the provision of each service in each environment is shown in the intersections of the table. The schedule may also include further information relating to the provision of a particular service in a particular environment, in the form of footnotes 66. This information may be associated with a particular intersection by a reference numeral 67. Other methods of showing such information may also be suitable.

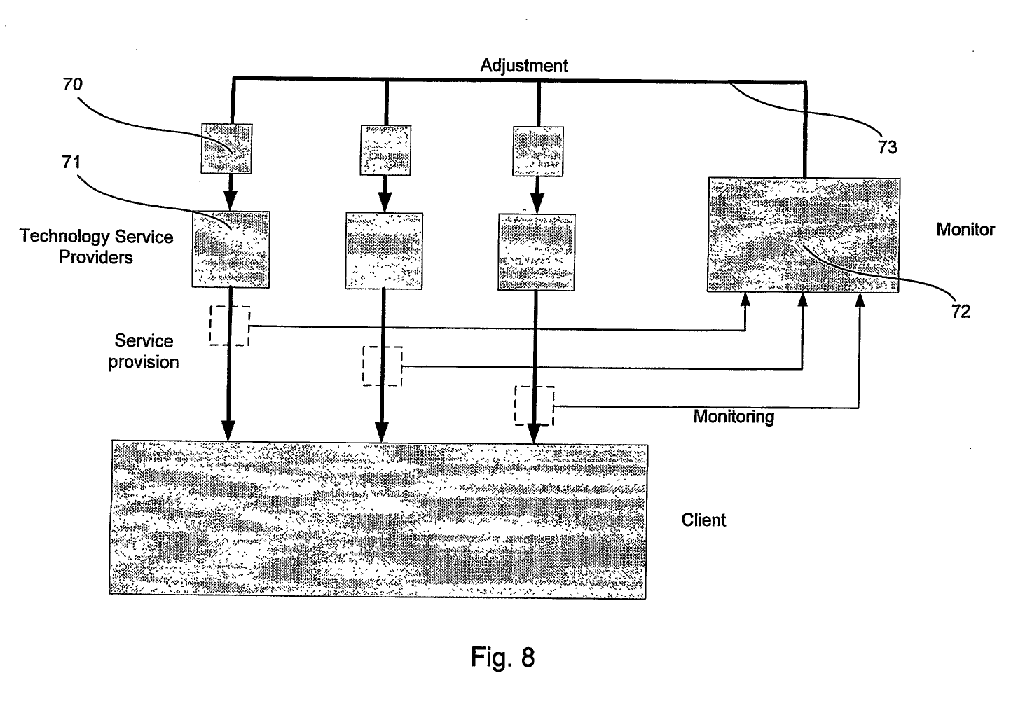

Once the contract has been agreed to, the services are provided in accordance with the agreement. Referring to FIG. 8, each service 70 is allocated to a responsible technology service provider 71, and is provided in accordance with the defined level of service and in accordance with the working practices of the practice corresponding to the service. If the service is to be delivered by the outsourcer then the responsible technology provider is the operational delivery group within the outsourcer organisation ultimately responsible for delivering the service.

During provision of the service 70 by the provider 71, monitoring 72 occurs to ensure the service is provided in accordance with the defined level of service; for example, ensuring that the volumes of calls are in line with volumes specified and that each call is answered within the target time. If the monitoring indicates that the service is not provided within the level of service then adjustment 73 of the service may be required. For example, adjustments could be made by increasing the number of people answering calls, by applying different technology within the environment or by fixing a defect in delivery of the service. Additionally, the quality may be adjusted or additional services may be added from the list.

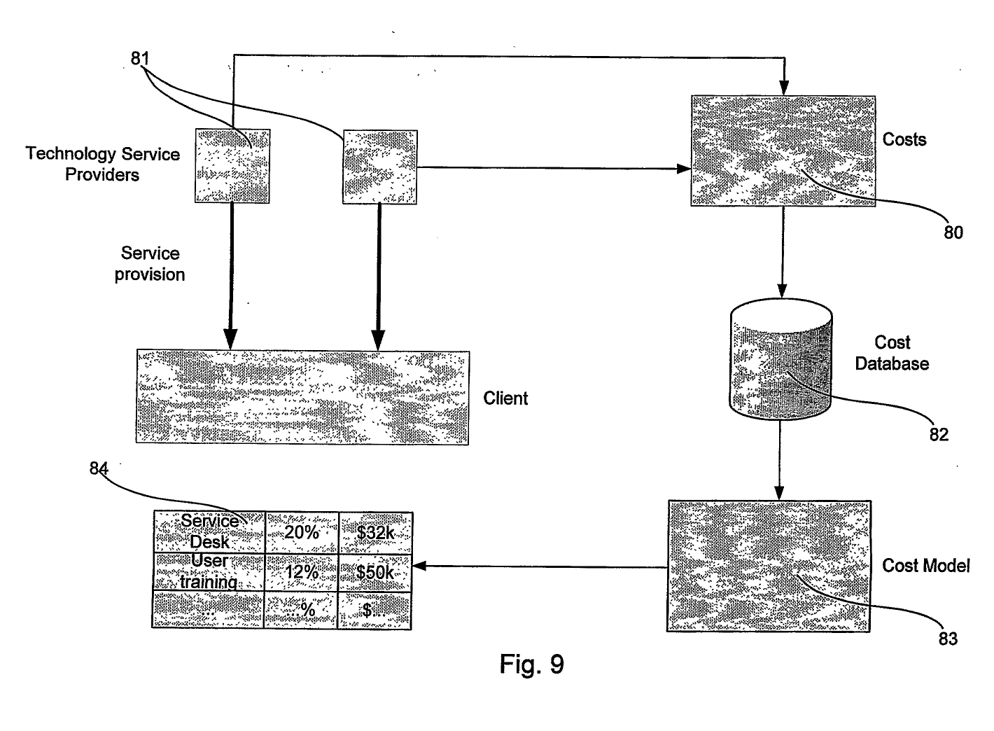

Referring to FIG. 9, costs 80 for delivering a service by a technology service provider 81 are generated and recorded into a database 82. A cost model 83 can be generated from this database for delivery of the cost of all the services that can provided by the outsourcer. The output of the cost model is input to the pricing model 84 The pricing model 84 sets out the price for each outsourced key service, based on the cost of providing that key service, the scope and volume of services to be provided and the markup (i.e. profit margin) imposed by the outsourcer. For example, the pricing model 84 in FIG. 9 shows a price of $50,000 for providing outsourced user training, with a markup of 12%. The advantage of this is the generation of prices for technology outsourcing agreements that are derived from the true cost of delivering the service. This ensures the outsourcer can offer services for a competitive price without undermining their profitability.

FIG. 10 shows an embodiment of a computer system on which the method may be implemented. The method may simply be executed on a computer 90 including a computer processor 91 and computer memory 92. The computer 90 preferably includes a visual display device 93 capable of displaying a graphical user interface 94. The computer preferably also includes an input device 95 such as a keyboard. Computer software suitable for implementing the method described above may be stored on a suitable medium such as the computer memory 92. Required databases may also be stored in computer memory 72. Of course, such a computer may also communicate with one or more external databases 96 and/or other computers 97 over a network 98 in order to implement the invention. It will be appreciated that the system can be developing using one of any number of programming languages and can be deployed within many hardware configurations.

It will be appreciated that some of the advantages of the present invention include breaking discussions about services into the component pieces bringing clarity to the discussion. In addition, the present invention easily generates contract schedules and changes to the schedules as required. The present invention further ensures that all contracts generated are consistent which makes it easier for people to “learn” a new contract and for technological providers to deliver against the contract. Finally, the present invention enables a connection between all the components of a technology outsourcing arrangement. This means that a specific metric can be traced back to a service selected, and a customer requirement. The traceability removes the ambiguity from what the client wants, to want the salesman for the outsourcer hears, to what the commercial team of the outsourcer prices for the service, to what the delivery team of the technology provider delivers.

The method of the invention also provides the following advantages:
The graphical presentation of the Matrix makes it is easier to see who is delivering each service, where service delivery is inconsistent or inappropriate within an environment, and where service delivery and the groups providing can be rationalised to help reduce costs.
It is easier to see if all the necessary services have been defined.
It is easier to ensure responsibility for all necessary services has been allocated
It is easier to add current information (delivery performance, improvement initiatives etc) to the contract information.
It is easier to modify as things change and to assess the impact of imminent change.
The scope of responsibility of each party is more clearly and accurately captured in the outsourcing agreement.
The invention is able to present all of the services for a contract on a single piece of paper (or a detailed view on a few sheets of A4-size paper).
It is easier to identify gaps in the delivery of the services.
A fixed list of services enables all relevant issues to be considered.
It is possible to add further information in a simple manner and to view the services, environments, suppliers and an indication of whether such further information has been added in a single, accessible matrix. This provides an accessible overview of the agreement, reducing error and required time and effort, but providing flexibility in terms of contract content.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. For example, while the present invention has been described in relation to information technology, it will be appreciated that the system may be adapted for use with the outsourcing of other technology. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A computer-implemented method of outsourcing technology services, comprising the steps of:
a. determining metrics to govern services by agreement between a client and an outsourcer;
b. selecting services required by the client from a fixed list of services and determining a quality for the selected service, wherein the selection and the quality of the selected services are dependent on the metrics, and wherein the services within the fixed list of services are organised within groups and at least one service corresponds to a predetermined practice;
c. generating an agreement between the outsourcer and the client for the provision of each selected service;
d. allocating the provision of each selected service to an appropriate technology service provider;
e. each technology service provider providing its allocated service according to the quality required and according to the corresponding predetermined practice;
f. monitoring the services provided in conjunction with the client; and,
g. adjusting the quality of the services or adding additional services from the list in response to the outcome of the monitoring.

2. The method of claim 1, wherein the services are information technology services.

3. The method of claim 1, wherein the metrics relate to any one or more from the set of the frequency of delivery; the quality of the service; the availability of components of the environment; and the ability of the environment to support the business.

4. The method of claim 1, including the step of determining a responsible party for delivery of the service from one of the outsourcer, the client, or a third party.

5. The method of claim 1, including the step of defining a plurality of environments for the client.

6. The method of claim 5, including the step of determining a responsible party for delivery of the service for each of the environments of the client, the responsible party being selected from one of the outsourcer, the client, or a third party.

7. The method of claim 5, wherein the environments are defined by one of infrastructure, data or business environments.

8. The method of claim 1, wherein the groups of services are organised based on functional grounds.

9. The method of claim 1, wherein the services include administration services, support services, maintenance services, and infrastructure services.

10. The method of claim 1, wherein the fixed list of services include administration services, support services, maintenance services, and infrastructure services.

11. The method of claim 10, wherein the services are grouped into groups of one or more services from the set of account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, internet services, application support capacity planning, architecture, consulting services & supplementary services, data management, network management, and system management.

12. The method of claim 10, wherein the services are ordered by grouping from administration services, support services, maintenance services, to infrastructure services.

13. The method of claim 10, wherein the fixed list of services is ordered by group, each group including services selected from account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, internet services, application support capacity planning, architecture, consulting services & supplementary services, data management, network management, to system management.

14. A computer-implemented method of determining pricing for one or more technology outsourcing services, comprising the steps of:
a. one or more operational delivery groups delivering technology outsourcing services using a list of services for one or more clients, wherein each service includes a level of quality for the service and each service corresponds to a process for performing the service and wherein each process defines working practices;
b. generating costs for each service delivered;
c. compositing the costs into a cost model for all services delivered; and
d. generating a pricing model from the cost model.

15. A computer-readable medium having stored thereon a computer program comprising instructions which, when executed by a computer, cause the computer to perform the steps of:
a. determining metrics to govern services by agreement between a client and an outsourcer;
b. selecting services required by the client from a fixed list of services and determining a quality for the selected service, wherein the selection and the quality of the selected services are dependent on the metrics, and wherein the services within the fixed list of services are organised within groups and at least one service corresponds to a predetermined practice;
c. generating an agreement between the outsourcer and the client for the provision of each selected service;
d. allocating the provision of each selected service to an appropriate technology service provider;
e. each technology service provider providing its allocated service according to the quality required and according to the corresponding predetermined practice;
f. monitoring the services provided in conjunction with the client; and
g. adjusting the quality of the services or adding additional services from the list in response to the outcome of the monitoring.
